(19) United States
(12) Patent Application Publication
(10) Pub. No.: US 2026/0081526 A1
(43) Pub. Date: Mar. 19, 2026

(54) SWITCHING ENERGY CAPTURE CIRCUIT

(71) Applicant: TEXAS INSTRUMENTS INCORPORATED, DALLAS, TX (US)

(72) Inventors: Neeraj KESKAR, ALLEN, TX (US); Robert A. NEIDORFF, MANCHESTER, NH (US)

(21) Appl. No.: 18/890,190

(22) Filed: Sep. 19, 2024

(51) Int. Cl. H02M 3/158; H02M 1/00

(52) U.S. Cl. CPC H02M 3/158; H02M 1/007

(57) ABSTRACT

In a described example, a circuit includes a switching converter comprising a switch having a first current input, a second current input, and a control input, a respective one of the first current input and the second current input having an associated parasitic impedance. An energy capture circuit has a third input and a first output, in which the third input is coupled to the respective one of the first current input and the second current input. A voltage regulator has a fourth input and a second output, in which the fourth input is coupled to the first output or an input voltage terminal, and the second output is coupled to a voltage terminal of the circuit.

### TECHNICAL FIELD

This description relates a circuit to recover switching energy.

### BACKGROUND

Power converters are used in a variety of applications to regulate the supply of electrical power. As an example, a controller can provide an input pulse-width modulated (PWM) signal to a driver circuit, which is configured to provide a drive signal to an output stage. The output stage can include one or more transistors that are switched between on and off states to supply electrical power at an output to which a load can be coupled. The switching of the transistors can result in switching loss due to parasitics, which can reduce efficiency of the power converter.

### SUMMARY

One described example provides a circuit that includes a switching converter, an energy capture circuit, and a voltage regulator. The switching converter includes a switch having a first current input, a second current input, and a control input, a respective one of the first current input and the second current input having an associated parasitic impedance. The energy capture circuit has a third input and a first output, in which the third input is coupled to the respective one of the first current input and the second current input. The voltage regulator has a fourth input and a second output, in which the fourth input is coupled to the first output or an input voltage terminal, and the second output is coupled to a voltage terminal of the circuit.

Another example circuit includes a switching converter, an energy capture circuit, and a voltage regulator. The switching converter includes a switch configured to turn on and off responsive to a switch control signal, in which the circuit comprises a parasitic impedance coupled to a respective switch terminal of the switch. The energy capture circuit is configured to clamp a voltage at the respective switch terminal and capture energy stored in the parasitic impedance responsive to the switch turning on and/or off. The power supply circuit is configured to provide an output voltage responsive to the captured energy.

Another described example provides a system that includes a controller, a driver circuit, a switching converter, a rectifier, a capacitor, and a voltage regulator. The controller includes a control output. The driver circuit includes a signal input, a bias input, and a driver output. The switching converter includes a switch having a first current input, a second current input, and a control input, in which a parasitic inductance is coupled at the first current input and the control input is coupled to the driver output. The rectifier includes a rectifier input and a rectifier output, in which the rectifier input is coupled to the first current input. The capacitor is coupled between the rectifier output and a ground terminal. The voltage regulator includes a regulator input and a regulator output, in which the regulator input is coupled to the rectifier output or to an input voltage terminal, and the regulator output is coupled to the bias input.

### BRIEF DESCRIPTION OF THE DRAWINGS

FIG. 1 is a schematic block diagram of an example circuit to recover energy from a switch.

FIG. 2 is a circuit diagram of an example power converter circuit that includes an energy capture circuit.

FIG. 3 is a circuit diagram of another example power converter circuit that includes an energy capture circuit.

FIGS. 4 and 5 are plots showing signals for a simulation of the circuit of FIG. 2.

FIG. 6 are plots comparing estimated and simulated voltages plotted over a range of currents.

FIG. 7 are plots of efficiency over a range of currents for the power converter of FIG. 2 with and without including the energy capture circuit.

### DETAILED DESCRIPTION

This description relates to circuitry to recover energy from a parasitic impedance associated with a switch responsive to the switch turning on and/or off.

As an example, a circuit includes a switching converter and an energy capture circuit. The switching converter includes one or more switches (e.g., transistors) configured to turn on and off responsive to a switch control signal. The switching converter can be a buck, boost, buck-boost, or other converter topology. An inherent parasitic impedance (e.g., parasitic inductance and/or capacitance) can be coupled to a respective terminal of the switch, such as from integrated circuit (IC) packaging in which the switch resides, a circuit board, and/or related connections with the respective terminal. The energy capture circuit is configured to clamp a voltage at the respective switch terminal and capture energy stored in the parasitic impedance responsive to the switch turning on and/or off. In some examples, a power supply circuit (e.g., a voltage regulator) can be configured to provide an output voltage responsive to the captured energy, which can be used to supply power to other circuitry, which can be internal to (e.g., part of) an IC that includes the switch and the energy capture circuit. In other examples, which can depend on the voltage across the parasitic impedance, the energy capture circuit (e.g., a diode and capacitor) can be coupled to other circuitry and be configured to provide the output voltage directly to the other circuitry.

In many existing approaches, switch transition rates are slowed down and/or active clamps are used to dissipate the energy stored in parasitics to prevent excessive voltage excursions across the switch. Unlike such existing approaches, which tend to dissipate or otherwise waste energy, the circuits and systems described herein are configured to recover energy stored in such parasitics. As described herein, the stored energy can be supplied to other circuitry. As a result, overall power efficiency can be improved, particularly at higher switching frequencies.

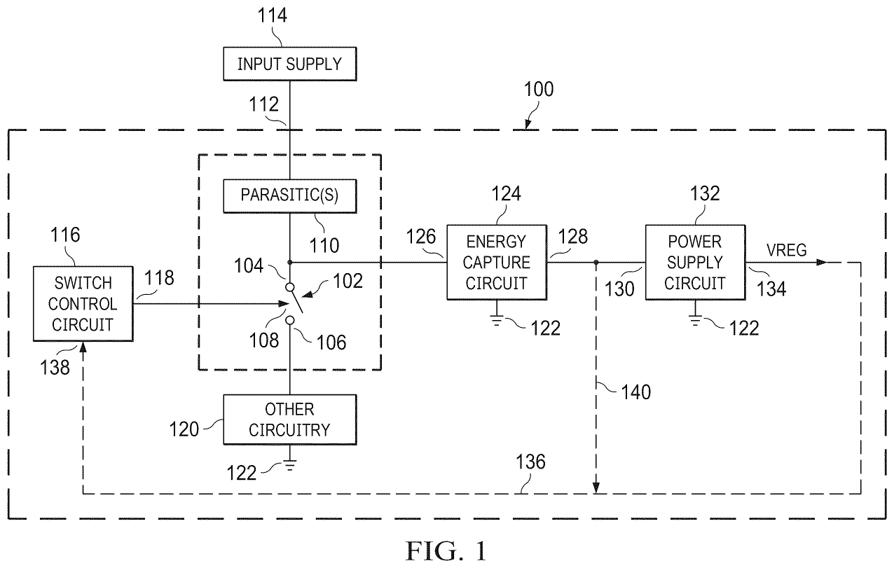

FIG. 1 is a schematic diagram of an example circuit 100 that includes a switching converter shown as a switch 102. The switch 102 includes a first current input 104, a second current input 106, and a control input 108. In an example, the switch 102 is a field effect transistor (FET), such as an n-channel or p-channel FET. In other examples, a different type of transistor can be used to implement the switch 102, such as a bipolar junction transistor (BJT), insulated-gate bipolar transistor (IGBT), laterally-diffused metal-oxide semiconductor (LDMOS) transistors, or the like. In the example of FIG. 1, the first current input 104 has an associated parasitic impedance, shown as 110, in which the parasitic impedance 110 is coupled between the first current input 104 and an input voltage terminal 112 of an input voltage supply 114. In other examples, one or more parasitic impedances can be associated with the second current input 106, the control input 108, and/or the first current input 104. The parasitic impedance 110 can be associated with any one or more respective input 104, 106, 108 of the switch 102 and can include a parasitic inductance, a parasitic capacitance, or a combination of parasitic inductance and capacitance.

The switch 102 is configured to turn on (e.g., provide a short circuit path) or turn off (e.g., provide an open circuit path) between current inputs 104 and 106 responsive to a switch control signal at the control input 108. For example, a switch control circuit 116 has an output 118 coupled to the control input 108 of the switch. The switch control circuit 116 can include logic, one or more drivers, and/or other circuitry configured to control the switch 102 to turn on and off according to application requirements. In some examples, other circuitry 120 is coupled between the second current input 106 and a ground terminal 122. The other circuitry can vary depending on a use environment. For example, the other circuitry 120 can include a load, one or more switches, power supply circuitry, or other circuitry to which the switch can provide an electrical signal (e.g., current and/or voltage).

An energy capture circuit 124 has an input 126 coupled to the first current input 104 (or other terminal) of the switch 102 having the associated parasitic impedance 110. The energy capture circuit 124 also has an output 128 coupled to an input 130 of a power supply circuit 132. Each of the energy capture circuit 124 and the power supply circuit 132 can also have a respective terminal coupled to the ground terminal 122 of the circuit 100. The power supply circuit 132 has an output 134, which can be or be coupled to a voltage terminal (e.g., a voltage rail) 136 of the circuit 100. In some examples, such as shown in FIG. 1, the switch control circuit 116 can have a voltage input 138 coupled to the output 134 of the power supply 132. In addition, or as an alternative example, the output 128 of the energy capture circuit 124 can be coupled to the voltage input 138, as shown by dashed line 140, to supply a voltage directly to the switch control circuit 116.

As described herein, the switch 102 is configured to turn on and off responsive to the switch control signal at the control input 108, which can be provided by the switch control circuit 116. The energy capture circuit 124 is configured to clamp a voltage at the first current input 104 and capture energy stored in the parasitic impedance 110 responsive to the switch turning on and/or off. For example, the energy capture circuit 124 includes a rectifier diode configured to rectify the voltage at the first current input 104 and provide a direct current indicative of energy stored in the parasitic impedance 110 responsive to the switch turning on and/or off. The energy capture circuit 124 can include one or more storage elements (e.g., one or more capacitors) configured to store energy according to the direct current that is provided by the rectification and provide a corresponding voltage signal at the output 128. The power supply circuit 132 is configured to provide an output voltage responsive to the voltage at 128 that depends on the captured energy. For example, the power supply circuit 132 is a voltage regulator configured to provide a regulated voltage VREG at the output 134, which can supply power to the switch control circuit 116 or other circuitry 120 that is part of or coupled to the circuit 100.

The circuit 100 can be or be implemented as part of an IC on a semiconductor die, which can be packaged in a mold compound to provide a packaged semiconductor device. In an example, the IC on the semiconductor die includes the switch 102 and at least a portion of the energy capture circuit 124 (e.g., up to including the entire energy capture circuit). In some examples, an energy storage element of the energy capture circuit 124 includes a discrete capacitor implemented within the packaged semiconductor device but coupled to the die containing the IC (e.g., through bond wires).

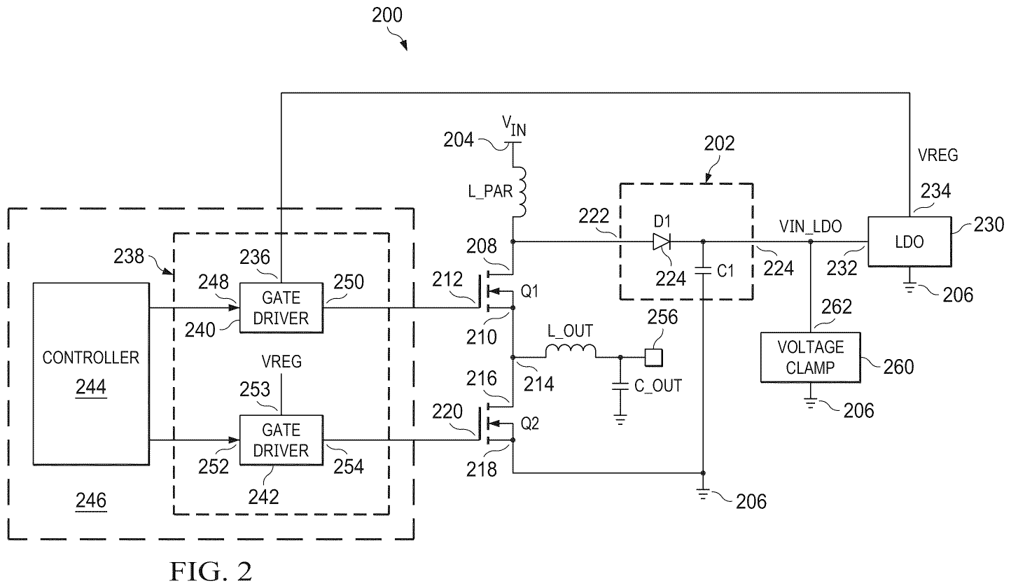

FIG. 2 is a circuit diagram of an example power converter circuit 200 (also referred to as a system or power converter) that includes an energy capture circuit 202. The power converter circuit 200 is one example that can be used to implement the circuit 100 of FIG. 1, in which the energy capture circuit 202 provides a further example of the energy capture circuit 124. Accordingly, the description of FIG. 2 refers to certain aspects of the circuit 100 of FIG. 1.

The power converter circuit 200 includes first and second switches, shown as transistors (e.g., FETs) Q1 and Q2, coupled in series between a voltage terminal 204 and a ground terminal 206. In the example of FIG. 2, the transistors Q1 and Q2 define a switching converter. The voltage terminal 204 can be coupled to an output of a voltage supply (e.g., the input supply 114 of FIG. 1) configured to provide an input voltage VIN (e.g., a DC voltage). The voltage supply can be on the same semiconductor device (e.g., IC chip) as some or all of the components of the power converter circuit 200. Alternatively, the voltage supply can be implemented external to a semiconductor device that includes the transistor Q1 through an electrical connection (e.g., a trace or wire).

The transistor Q1 has a first current input (e.g., a drain) 208, a second current input (e.g., source) 210, and a control input (e.g., gate) 212. The first current input 208 is coupled to the voltage terminal 204 through a parasitic impedance, which is depicted as including a parasitic inductance (e.g., a drain inductance of Q1) L_PAR. The second current input 210 is coupled to a switching terminal (e.g., a switching node of a half-bridge defined by Q1 and Q2) 214. The other transistor Q2 can be coupled between the switching terminal 214 and the ground terminal 206. In the example of FIG. 2, the transistor Q2 has a first current input (e.g., a drain) 216, a second current input (e.g., source) 218, and a control input (e.g., gate) 220, in which the first current input 216 is coupled to the switching terminal 214 and the second current input 218 is coupled to the ground terminal 206. For example, the transistors Q1 and Q2 are power FETs, which can be n-channel FETS (NFETs) or p-channel FETs (PFETs). In the example of FIG. 2, the transistors Q1 and Q2 can define a power stage (e.g., a half-bridge circuit), in which Q1 is a high-side FET and Q2 is a low-side FET. The transistors Q1 and Q2 can be implemented by other types of transistors in other examples, such as described herein.

The energy capture circuit 202 has an input 222 and an output 224, in which the input 222 is coupled to the first current input 208. In an example, energy capture circuit 202 includes a rectifier having a rectifier input coupled to the first current input 208 and a rectifier output coupled to the output of the energy capture circuit 202.

In the example of FIG. 2, the energy capture circuit 202 includes a diode D1 (e.g., a rectifier diode) and a capacitor C1. The diode D1 includes an anode and a cathode, in which the anode is coupled to the first current input (e.g., drain) 208 of the transistor Q1. The cathode of the diode D1 is coupled to the output 224 of the energy capture circuit 202. The capacitor C1 is coupled between the output 224 and the ground terminal 206. The diode can be a regular semiconductor diode, or a transistor (e.g., a diode connected transistor emulating a diode) configured to enable current flow in only one direction can be used.

The power converter circuit 200 also includes a voltage regulator, shown as a low drop-out (LDO) regulator 230. The LDO regulator 230 has a regulator input 232, a regulator output 234. The regulator input 232 is coupled to the output 224 of the energy capture circuit 202, and the LDO regulator 230 can also be coupled to the ground terminal 206. The regulator output 234 can be coupled to a bias input 236 of a drive circuit 238. The LDO regulator 230 can be an on-chip LDO capable of operating based on the VIN_LDO voltage.

The drive circuit 238 includes one or more gate drivers 240 and 242 configured to provide drive signals to the control inputs 212 and 220 of the respective transistors Q1 and Q2 responsive to control (e.g., logic) signals provided by a controller 244. The controller 244 and gate drivers 240 and 242 can define a switch control circuit 246 (e.g., the switch control circuit 116 of FIG. 1). The gate driver 240 has a signal input 248, the bias input 236, and a driver output 250. The signal input 248 is coupled to a signal output of the controller 244 and the driver output is coupled to the control input (e.g., gate) 212 of the transistor Q1. Similarly, the gate driver 242 has a signal input 252, a bias input 253, and a driver output 254, in which the signal input 252 is coupled to another signal output of the controller 244 and the driver output 254 is coupled to the control input (e.g., gate) 220 of the transistor Q2. In some examples, the bias input 253 can be coupled to the regulator output 234 to receive the regulated voltage. In other examples, the bias input 253 can be coupled to another regulator circuit, which is separate from the regulator 230, to receive a respective bias voltage.

In some examples, the switching terminal 214 can be coupled to an output terminal 256 of the power converter circuit 200 through an LC network, which includes an inductor L_OUT and a capacitor C_OUT. The switch control circuit 246 can be configured to control the respective transistors Q1 and Q2 (e.g., turn Q1 and Q2 on and off) to provide an output voltage VOUT at the output terminal 256.

As a further example, the controller 244 includes one or more control loops configured to provide respective control signals to regulate the output voltage VOUT at the output terminal 256. The control signals can be signal pulses, such as pulse-width modulated (PWM) signals having a variable duty cycle based on one or more sensed conditions (e.g., representative of voltage and/or current) of the power converter. The controller 244 can provide respective control signals to the gate driver inputs 248 and 252. The gate drivers 240 and 242 can provide respective drive signals (e.g., gate drive signals) to the control inputs 212 and 220 of the transistors Q1 and Q2 responsive to the respective control signals. Each of the transistors Q1 and Q2 can turn on or off (e.g., partially, or wholly) depending on the value of the drive signal received at the control input 212, 220 thereof.

As described herein, the parasitic inductance L_PAR in series with the transistor Q1 is configured to store parasitic energy based on current flow through the transistor Q1. Accordingly, responsive to the transistor Q1 turning off, while carrying current, the energy stored in the parasitic inductance L_PAR is recovered by the energy capture circuit 202, which reduces otherwise large voltage excursions across the transistor Q1 that has turned off. The energy capture circuit 202 can also recover excess energy from the parasitic inductance L_PAR responsive to the transistor Q1 being turned on.

For example, the diode D1 is configured to rectify a voltage at the first current input 208 and provide a direct current responsive to the transistor Q1 turning on and/or off. The capacitor C1 is configured to store energy and provide a capacitor voltage (shown at VIN_LDO at the output 224 (e.g., a rectified rail voltage) responsive to the current provided by the diode D1. The LDO regulator 230 is configured to provide a regulated voltage VREG at the regulator output 234 responsive to the capacitor voltage VIN_LDO at the regulator input 232. The regulated voltage VREG can be provided to one or more components in the circuit 200, such as to provide a bias voltage at the bias input 236 of the gate driver 240. Additionally, or alternatively, the regulated voltage VREG can be provided to a bias input of the other gate driver 242. As a further example, the diode D1 is configured as a reverse blocking structure (e.g., when VIN_LDO exceeds VIN) so that the VREG can also be supplied externally from an IC that includes the LDO regulator 230. For example, the regulator output 234 can be coupled to an output terminal (e.g., pin) of an IC chip to supply the regulated voltage off-chip.

The voltage VIN_LDO can be shown to be approximately equal to:

$$VIN\_LDO = VIN - {V}_{d} + \frac{1}{2} L\_PAR \cdot {I}_{PK}^{2} \cdot \frac{{f}_{SW}}{{I}_{LDO}} , \qquad Eq . 1$$

where: V_{d} is the voltage drop across the clamp diode,
   I_{PK} is the peak inductor current during HFET turn-on or turn-off,
   f_{SW} is the switching frequency, and
   I_{LDO} is the current consumed by the LDO (including fixed bias current and gate drive current).
      As shown by the above equation, during steady state operation, the capacitor voltage VIN_LDO across C1 exceeds the input supply voltage VIN, which facilitates operation of the LDO regulator 230 at lower VIN voltages with reduced issues about LDO dropout voltage. However, at power-up of the circuit 200, during light load conditions, and/or prior to energy being stored in the parasitic inductance L_PAR, the capacitor voltage VIN_LDO can be approximately one diode-drop (e.g., approximately 0.7V) below VIN, which is sufficient to power the LDO regulator 230. As the load increases, more energy is stored in the parasitic inductance L_PAR and the capacitor voltage VIN_LDO increases beyond VIN, which reverse biases the diode D1. Thus, the power converter circuit 200 can capture energy stored in parasitics instead of dissipating and/or wasting such energy as done in many existing approaches. As a result, the overall efficiency of the power converter 200 can be improved, particularly at higher switching frequencies, compared to such existing approaches.

As a further example, the voltage drop across the diode V_{d}≈0.7V, although other voltage values (e.g., lower voltage drop) can be implemented, such as by using a Schottky diode or switch emulating the diode D1. The peak inductor current I_{PK} can vary depending on the application and, in some examples, be 60A or even higher. The switching frequency can also depend on the application and in some examples range from about 300 kHz to several MHz (e.g., 5 MHz or higher). The current I_{LDO} similarly can vary depending on the application, for example, typically in the range of tens of mA (e.g., 10 mA to 100 mA).

In some examples, the power converter circuit 200 also includes a voltage clamp 260 having a clamp input 262 coupled to the output 224. The voltage clamp 260 is configured to clamp the capacitor voltage VIN_LDO above a voltage threshold, which can protect the LDO regulator from an increased capacitor voltage VIN_LDO that can be provided at the regulator input 232.

As a further example, the power converter circuit 200 can be implemented as on one or more ICs. In a first example, one or both of the transistors Q1 and Q2 can be implemented on a semiconductor die that includes the diode D1. In the first example, the capacitor C1 can be implemented as one or more discrete components that can be within the same packaged semiconductor device as the semiconductor die containing D1. In another embodiment of the first example, the capacitor C1 can be external to the packaged semiconductor device that includes D1 and Q1 and/or Q2. In the first example, the controller 244 and/or the drive circuit 238 can be implemented in one or more ICs of semiconductor devices that are separate from and coupled to the semiconductor device including Q1 and/or Q2, and D1. In a second example, one or both of the transistors Q1 and Q2, the diode D1, and the capacitor C1 are implemented in on the same semiconductor die within a packaged semiconductor device. By implementing the capacitor C1 on the same die as the diode and switches, the performance and efficiency of the energy capture circuit can be increased. In the second example, the controller 244 and/or the drive circuit 238 can be implemented in one or more ICs of semiconductor devices that are separate from and coupled to the semiconductor device including Q1, Q2, D1, and C1. In the first and second examples, each of the transistors Q1 and Q2 can be implemented in separate ICs in the same or different semiconductor devices or the transistors Q1 and Q2 can be implemented in the same IC.

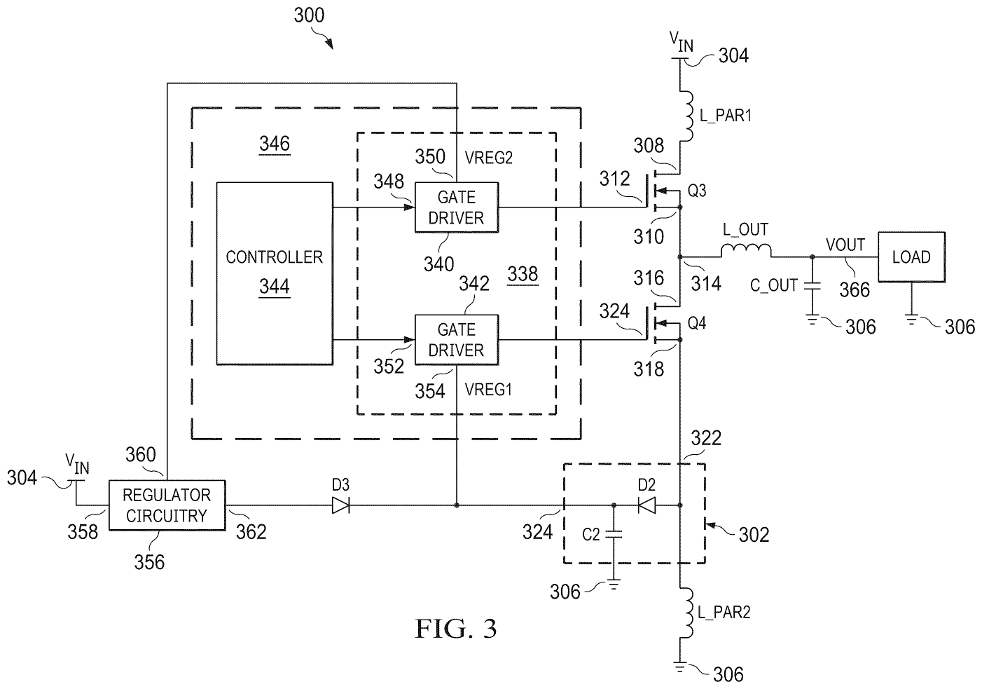

FIG. 3 depicts another example power converter circuit 300 (also referred to as a system) that includes an energy capture circuit 302. The power converter circuit 300 is can be used to implement the circuit 100 of FIG. 1, in which the energy capture circuit 302 provides a further example of the energy capture circuit 124. Accordingly, the description of FIG. 3 refers to certain aspects of the circuit 100 of FIG. 1. The power converter circuit 300 can be a half-bridge (e.g., the same or similar to the converter circuit 200 of FIG. 2) or another converter topology.

The power converter circuit 300 includes first and second switches, shown as transistors (e.g., FETs) Q3 and Q4, coupled in series between a voltage terminal 304 and a ground terminal 306. The voltage terminal 304 can be coupled to an output of a voltage supply (e.g., the input supply 114 of FIG. 1) configured to provide an input voltage VIN (e.g., a DC voltage). The voltage supply can be on the same semiconductor device (e.g., IC chip) as some or all of the components of the power converter circuit 300. Alternatively, the voltage supply can be implemented external to a semiconductor device that includes the transistor Q3 through an electrical connection (e.g., a trace or wire).

The transistor Q3 has a first current input (e.g., a drain) 308, a second current input (e.g., source) 310, and a control input (e.g., gate) 312. The first current input 308 is coupled to the voltage terminal 304 through a parasitic impedance (e.g., drain inductance of Q3) L_PAR1. The second current input 310 is coupled to a switching terminal 314. The other transistor Q4 can be coupled between the switching terminal 314 and the ground terminal 306. In the example of FIG. 3, the transistor Q4 has a first current input (e.g., a drain) 316, a second current input (e.g., source) 318, and a control input (e.g., gate) 320. The first current input 316 is coupled to the switching terminal 314 and the second current input 318 is coupled to the ground terminal 306 through a parasitic impedance (e.g., source inductance of Q4) L_PAR2. The transistors Q3 and Q4 can be FETS or other types of transistors in other examples, such as described herein.

The energy capture circuit 302 has an input 322 and an output 324, in which the input 322 is coupled to the second current input (e.g., source) 318 of Q4. The energy capture circuit 302 can include a rectifier. In the example of FIG. 3, the energy capture circuit 302 includes a diode D2 (e.g., a rectifier diode) and a capacitor C2. The diode D2 includes an anode and a cathode, in which the anode is coupled to the second current input (e.g., source) 318 of the transistor Q4. The cathode of the diode D1 is coupled to the output 324 of the energy capture circuit 302. The capacitor C1 is coupled between the output 324 and the ground terminal 306. The diode D2 can be a regular semiconductor diode or a transistor (e.g., a diode connected transistor).

A drive circuit 338 includes one or more gate drivers 340 and 342 configured to provide drive signals to the control inputs 312 and 320 of the respective transistors Q3 and Q4 responsive to control (e.g., logic) signals provided by a controller 344. The controller 344 and gate drivers 340 and 342 can define a switch control circuit 346 (e.g., the switch control circuit 116 of FIG. 1). The gate driver 340 has a signal input 348, a bias input 350, and a driver output 350. The signal input 348 is coupled to a signal output of the controller 344 and the driver output is coupled to the control input (e.g., gate) 312 of the transistor Q3. Similarly, the gate driver 342 has a signal input 352, a bias input 354, and a driver output. The signal input 352 is coupled to another signal output of the controller 344 and the driver output is coupled to the control input (e.g., gate) 320 of the transistor Q4.

In the example of FIG. 3, the output 324 of the energy capture circuit 302 is coupled to the bias input 354 of the gate driver 342. In this way, the energy capture circuit 302 can be configured to provide a voltage VREG1, corresponding to a voltage across the capacitor C2, to directly power the gate driver 3421 responsive to energy stored in L_PAR2. The voltage VREG1 can be a regulated voltage (e.g., substantially fixed voltage). Alternatively, the voltage VREG1 can vary during operation of the power converter circuit 300 according to the available electrical energy from the parasitic impedance L_PAR2 for charging the capacitor C2 and the amount of power used by the gate driver 342.

In some examples, the power converter circuit 300 can include a regulator circuit 356 having a voltage input 358 and voltage outputs 360 and 362. The voltage input 358 can be coupled to the voltage terminal 304 to receive VIN or, in other examples, voltage input 358 can be coupled to a different voltage source. The voltage output 362 can be coupled to the bias input 354. In some examples, a diode D3 can be coupled between the voltage output 362 and the bias input 354 to prevent current flow from the energy capture circuit 302 into the regulator circuit 356. The regulator circuit 356 can be configured to provide a regulated voltage to the bias input 354 of the gate driver 342, such as during low load current conditions that result in lower energy being sourced from the parasitic impedance L_PAR2.

The regulator circuit 356 can also be configured to provide a regulated voltage VREG2 to the bias input 350 of the gate driver 340. In the example shown in FIG. 2, the voltage output 360 of the regulator circuit 356 is coupled to the bias input 350 of the gate driver 340. In other examples, the bias input 350 of the gate driver 340 can be coupled to the output 324 of the energy capture circuit 302 (also coupled to the bias input 354), such that both gate drivers 340 and 342 can be powered by the energy capture circuit 302 and/or the regulator circuit.

The regulator circuit 356 can implement separate regulators (e.g., LDOs) configured to provide each of VREG1 and VREG2 at the respective outputs 362 and 360. Alternatively, common circuitry can be configured to provide each of VREG1 and VREG2 at the respective outputs 362 and 360. Regardless of how the regulator circuit 356 is implemented, the voltage VREG2 at the bias input 350 can be the same or different from the voltage VREG1 at the bias input 354

The switching terminal 314 can be coupled to an output terminal 356 of the power converter circuit 300 through an LC network, which includes an inductor L_OUT and a capacitor C_OUT. The switch control circuit 346 thus can be configured to control the respective transistors Q3 and Q4 (e.g., turn Q3 and Q4 on and off) to provide an output voltage VOUT at the output terminal 356. The controller can be configured to provide respective control signals to the gate driver inputs 348 and 352, and the gate drivers 340 and 342 can provide respective drive signals (e.g., gate drive signals) to the control inputs 312 and 320 of the transistors Q3 and Q4 responsive to the respective control signals, such as described with respect to FIG. 2.

As described herein, the parasitic inductance L_PAR2 in series with the transistor Q4 is configured to store electrical energy based on current flow through the transistor Q4 responsive to Q4 turning on and/or off. For example, the diode D2 is configured to rectify a voltage at the first current input 322 and provide a direct current at the first output responsive to the transistor Q4 turning on and/or off. The parasitic impedance L_PAR2 stores electrical energy responsive to the transistor Q3 turning on and/or off during load conditions. The capacitor C2 is configured to store energy and provide a capacitor voltage at the output 324 (e.g., a rectified voltage) responsive to the current provided by the diode D2. The amount of energy stored in the parasitic impedance L_PAR2 and current sourced from the parasitic impedance L_PAR2 can depend on the load conditions during switching of Q4. While the energy captured by the energy capture circuit can be effectively used to power internal circuitry within an IC or SOC device, in other examples, the voltage VREG1 can be supplied from the output 324 through a terminal externally from an IC that includes the energy capture circuit 302.

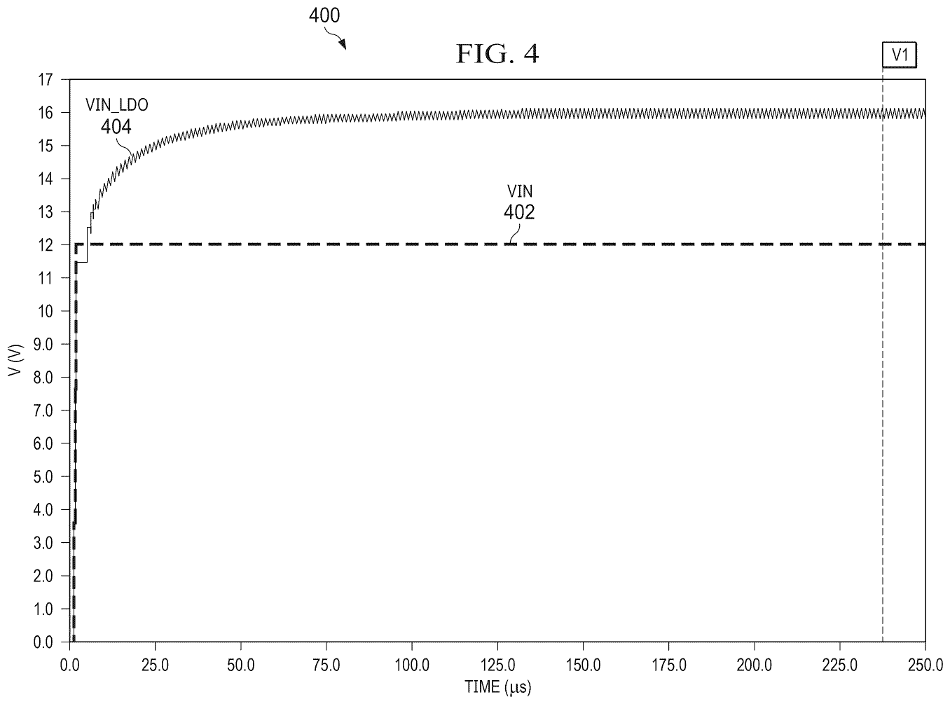

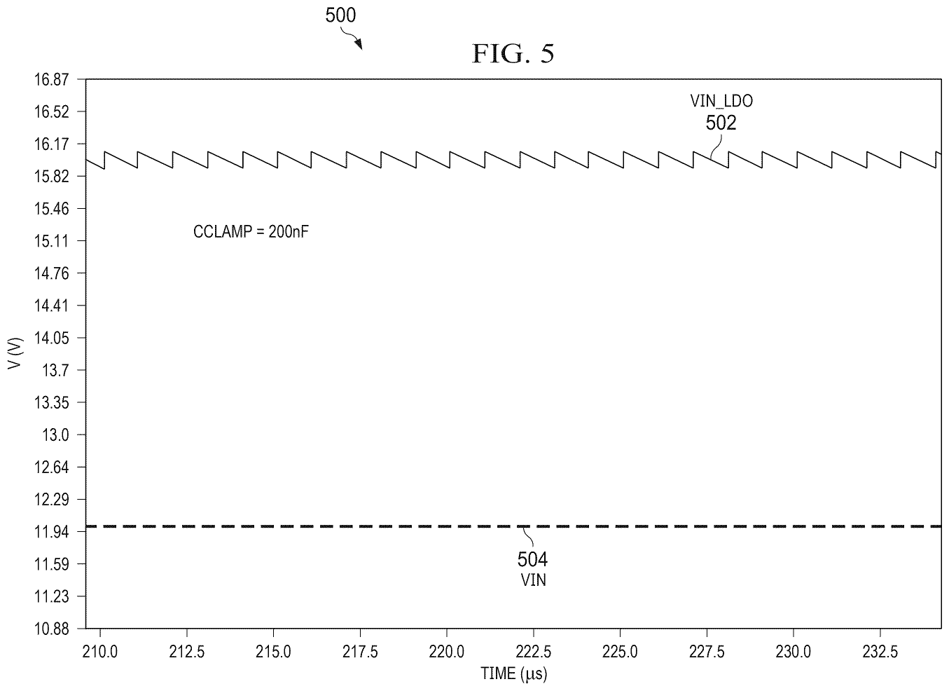

FIGS. 4 and 5 are plots 400 and 500 showing signal waveforms for a simulation of the power converter circuit 200 of FIG. 2. Accordingly, the description of FIGS. 4 and 5 also refers to FIG. 2. The plot 400 depicts the input voltage VIN, shown at 402, which is received at the voltage terminal 204, and the capacitor voltage VIN_LDO, shown at 404, which is provided at 224 by the energy capture circuit 202. FIG. 5 also depicts the input voltage VIN, shown at 502 and the capacitor voltage VIN_LDO, shown at 504; however, with an increased magnification compared to FIG. 4. Thus, the capacitor voltage VIN_LDO 504 appears as a sawtooth waveform with each switching cycle of the transistor Q1.

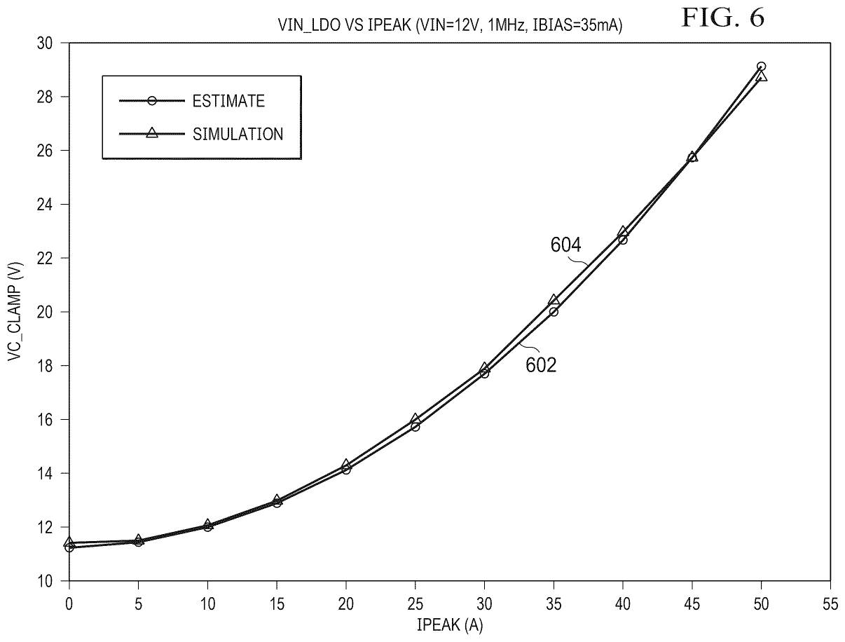

FIG. 6 are plots 602 and 604 comparing estimated and simulated versions of the capacitor voltage VIN_LDO plotted over a range of currents. Specifically, FIG. 6 shows that the estimated capacitor voltage 602 (e.g., determined from Eq. 1 herein) closely tracks the simulated capacitor voltage 604.

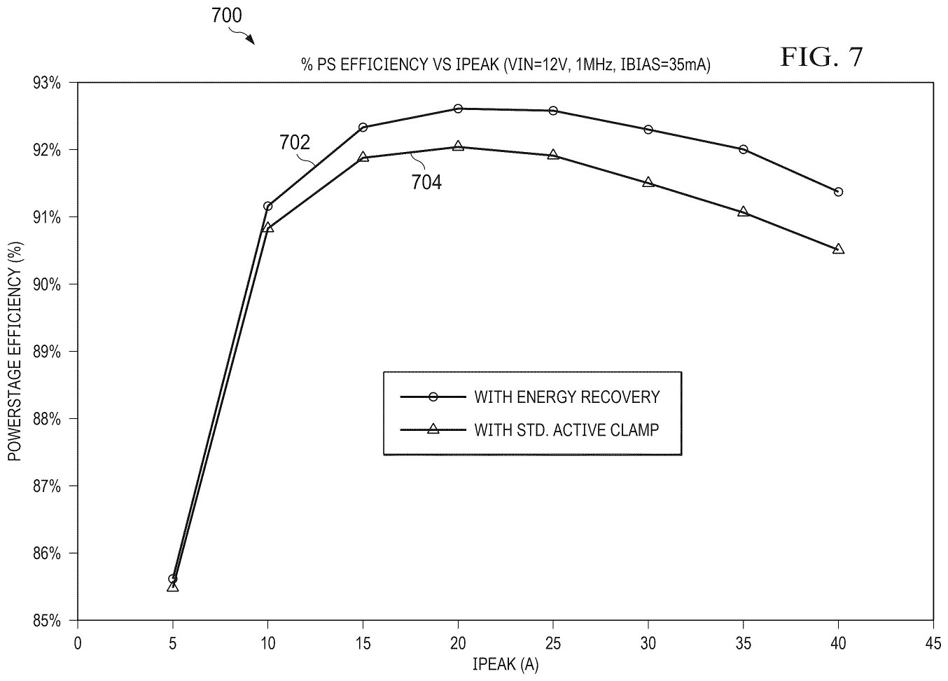

FIG. 7 depicts plots 702 and 704 demonstrating the efficiency of the power converter circuit 200 of FIG. 2 for simulations over a range of currents. The simulations were performed with a continuous conduction of inductor current, VIN=12V, f_{SW}=1 MHz, and I_{LDO}=35 mA (as measured for a typical 35-40 A part). The plot 702 demonstrates the efficiency for the circuit 200 including the energy capture circuit 202 and the plot 704 shows efficiency for the circuit 200 in the absence of the energy capture circuit but with an active clamp. Thus, as shown, the inclusion of the energy capture circuit resulted in an efficiency improvement ranging from 0.6% to 1% in the 20 A to 35 A current range.

In this description, numerical designations “first”, “second”, etc. are not necessarily consistent with same designations in the claims herein. Additionally, the term “couple” may cover connections, communications, or signal paths that enable a functional relationship consistent with this description. For example, if device A generates a signal to control device B to perform an action, then: (a) in a first example, device A is directly coupled to device B; or (b) in a second example, device A is indirectly coupled to device B through intervening component C if intervening component C does not alter the functional relationship between device A and device B, so device B is controlled by device A via the control signal generated by device A.

Also, in this description, a device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof. Furthermore, a circuit or device described herein as including certain components may instead be configured to couple to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor wafer and/or integrated circuit (IC) package) and may be configured to couple to at least some of the passive elements and/or the sources to form the described structure, either at a time of manufacture or after a time of manufacture, such as by an end user and/or a third party.

Modifications are possible in the described embodiments, and other embodiments are possible, within the scope of the claims.

What is claimed is:

1. A circuit comprising:
a switching converter comprising a switch having a first current input, a second current input, and a control input, a respective one of the first current input and the second current input having an associated parasitic impedance;
an energy capture circuit having a third input and a first output, in which the third input is coupled to the respective one of the first current input and the second current input; and
a voltage regulator having a fourth input and a second output, in which the fourth input is coupled to the first output or an input voltage terminal, and the second output is coupled to a voltage terminal of the circuit.

2. The circuit of claim 1, wherein the switch comprises a field effect transistor (FET), the parasitic impedance comprises a parasitic inductance at a drain of the FET, and the third input is coupled to the drain of the FET.

3. The circuit of claim 2, wherein the FET is a first FET having a source coupled to a switching terminal, the drain of the first FET is coupled to the input voltage terminal, and the circuit further comprises:
a second FET coupled between the switching terminal and a ground terminal.

4. The circuit of claim 2, wherein the energy capture circuit comprises:
a diode having an anode and a cathode, in which the anode is coupled to the drain of the FET, and the cathode is coupled to the first output; and
a capacitor coupled between the first output and a ground terminal.

5. The circuit of claim 4, wherein the voltage regulator comprises a low drop-out voltage regulator.

6. The circuit of claim 5, further comprising:
a gate driver having a drive output and a bias voltage input, in which the drive output is coupled to a gate of the FET, and the bias voltage input is coupled to the second output of the voltage regulator.

7. The circuit of claim 6, wherein:
the diode is configured to rectify an AC voltage at the anode and provide a rectified voltage at the first output responsive to the switch being turned on and/or off,
the capacitor is configured to stored energy therein responsive to the rectified voltage, and
the low drop-out voltage regulator is configured to provide a regulated voltage to the bias voltage input of the gate driver.

8. The circuit of claim 7, further comprising a semiconductor die that comprises an integrated circuit comprising the FET and the diode.

9. The circuit of claim 8, wherein the integrated circuit of the semiconductor die comprises the capacitor or the capacitor is within a packaging of a mold compound that comprises the semiconductor die.

10. The circuit of claim 1, wherein the energy capture circuit comprises:
a diode having an anode and a cathode, in which the anode is coupled to the respective one of the first current input and the second current input, and the cathode is coupled to the first output; and
a capacitor coupled between the first output and a ground terminal.

11. The circuit of claim 1, wherein the energy capture circuit comprises:
a rectifier configured to rectify a voltage at the respective one of the first current input and the second current input and provide a rectified voltage at the first output responsive to the switch turning on and/or off; and
a capacitor configured to store energy and provide a capacitor voltage at the first output responsive to the rectified voltage,
wherein the voltage regulator is configured to provide a regulated voltage at the second output responsive to the capacitor voltage.

12. The circuit of claim 11, further comprising:
a control circuit configured to provide a control signal, in which the switch is configured to turn on or off responsive to the control signal; and
a voltage clamp having a clamp input coupled to the first output, the voltage clamp configured to clamp the capacitor voltage above a voltage threshold.

13. A circuit, comprising:
a switching converter comprising a switch configured to turn on and off and provide a converter output voltage responsive to a switch control signal, in which the switch comprises a parasitic impedance at a respective switch terminal of the switch; and
an energy capture circuit configured to capture energy stored in the parasitic impedance at the respective switch terminal responsive to the switch turning on and/or off.

14. The circuit of claim 13, wherein the switch comprises a field effect transistor (FET), and the parasitic impedance comprises a parasitic inductance at a drain of the FET.

15. The circuit of claim 14, wherein the energy capture circuit comprises:
a rectifier configured to rectify the voltage at the respective switch terminal and provide a direct current responsive to the switch turning on and off; and
a capacitor configured to store the captured energy and provide a capacitor voltage responsive to the direct current, wherein the power supply circuit is configured to provide the output voltage responsive to the capacitor voltage.

16. The circuit of claim 15, further comprising a voltage clamp configured to clamp the capacitor voltage above a threshold.

17. The circuit of claim 15, wherein:
the rectifier comprises a diode, the FET is a first FET having the drain thereof coupled to an input voltage terminal and a source coupled to a switching terminal,
a power supply circuit comprising a voltage regulator configured to provide a regulated voltage responsive to the capacitor voltage, and
the circuit further comprises:
a second FET coupled between the switching terminal and a ground terminal;
a gate driver configured to provide a drive signal to a gate of the first FET responsive to a control signal and the regulated voltage; and
a controller configured to provide the control signal.

18. The circuit of claim 17, further comprising a semiconductor die that comprises an integrated circuit, in which the integrated circuit comprises the first FET, the second FET, and the diode, and the integrated circuit of the semiconductor die further comprises the capacitor or the capacitor is within a packaged semiconductor device that comprises the semiconductor die.

19. A system, comprising:
a controller having a control output;
a driver circuit having a signal input, a bias input, and a driver output;
a switching converter comprising a switch having a first current input, a second current input, and a control input, in which a parasitic inductance is at a respective one of the first current input or the second current input, and the control input is coupled to the driver output;
a rectifier having a rectifier input and a rectifier output, in which the rectifier input is coupled to the respective one of the first current input or the second current input; and
a capacitor coupled between the rectifier output and a ground terminal; and
a voltage regulator having a regulator input and a regulator output, in which the regulator input is coupled to the rectifier output or to an input voltage terminal, and the regulator output is coupled to the bias input.

20. The system of claim 19, further comprising a voltage clamp in parallel with the capacitor, wherein:
the rectifier is configured to rectify voltage at the rectifier output and provide a direct current signal responsive to the switch turning on and off,
the capacitor is configured to store energy and provide a capacitor voltage responsive to the direct current signal,
the regulator input is coupled to the rectifier output,
the voltage regulator is configured to provide a regulated voltage at the regulator output responsive to the capacitor voltage, and
and the voltage clamp is configured to clamp the capacitor voltage above a threshold.

21. The system of claim 19, wherein:
the regulator voltage input is coupled to the input voltage terminal,
the rectifier is configured to rectify voltage at the rectifier input and provide a direct current signal responsive to the switch turning on and/or off,
the capacitor is configured to store energy and provide a capacitor voltage at the rectifier output responsive to the direct current signal,
the regulator input is coupled to the voltage input supply,
a diode is coupled between the regulator output and the bias input, and
the voltage regulator is configured to provide a regulated voltage at the regulator output and a voltage is provided at the bias input based on the regulated voltage and the capacitor voltage.
